(19) United States
(12) Patent Application Publication
(10) Pub. No.: US 2007/0131205 A1
(43) Pub. Date: Jun. 14, 2007

(54) Fuel efficiency enhancing device

(76) Inventors: Jui-chang Wang, Taichung City (TW); Yu-Jun Wang, Taichung City (TW)

Correspondence Address: LEONG C LEI, PMB # 1008, 1867 YGNACIO VALLEY ROAD, WALNUT CREEK, CA, 94598, US

(21) Appl. No.: 11/298,671

(22) Filed: Dec. 12, 2005

(51) Int. Cl. F02M 27/00; F02M 57/02

(52) U.S. Cl. 123/538; 123/446

(57) ABSTRACT

A fuel efficiency enhancing device that is used inside or outside of the fuel tank of a motor vehicle is provided. The fuel efficiency enhancing device has a casing member made of Teflon, inside which far infrared and magnetic members are installed in a closed compartment without any contact to the external environment. The fuel efficiency enhancing device uses both the far infrared and magnetism to break up and activate the fuel molecules so as to achieve a superior fuel economy.

### BACKGROUND OF THE INVENTION

(a) Technical Field of the Invention

The present invention generally relates to fuel efficiency enhancing devices, and more particularly to a fuel efficiency enhancing device using both magnetism and far infrared to achieve better fuel economy.

(b) Description of the Prior Art

Despite that the depletion of natural energy resources shows no sign of relief, a full-scale, substitute energy source is yet to be discovered. With the energy crisis right at the door steps, currently people could only rely on more efficient usage of the existing energy resources.

As a result, quite a few fuel efficiency enhancing devices for automobiles, or fuel economizers, have been provided. FIG. 1 is a perspective diagram showing the structure of a conventional fuel economizer. As illustrated, the device contains two corresponding casing members 11 which jointly form a cylindrical body. Each of the casing members 11 has a hollow compartment 12 and two blades 13 at the two ends of the casing member 11 respectively. Each of the blades 13 has through holes 131 through which bolts and nuts 14 could be applied so that the two casing members 11 together could clamp around a section of the fuel line (not shown). As fuel flows through the fuel line and before the fuel enters the combustion chamber, an activation mechanism installed inside the space formed by the hollow compartments 12 helps to break down the molecular mechanics of the fuel so that the fuel would bum more completely, resulting in a more efficient rung engine and an increase in miles per gallon.

However, the fuel lines of vehicles of different models and makes are not always the same, leading to difficulties in the installation of the conventional fuel economizers. On the other hand, the fuel economizers are usually installed inside the engine room of a vehicle, and the high temperature there would inevitably impair the function of the fuel economizer significantly, if not rendering it total useless.

### SUMMARY OF THE INVENTION

The primary purpose of the present invention is to provide a novel fuel efficiency enhancing device that is used inside or outside the fuel tank of a motor vehicle, instead of around the fuel line in the engine room. The fuel efficiency enhancing device uses both the far infrared and magnetism to break up and activate the fuel molecules so as to achieve a superior fuel economy. The fuel efficiency enhancing device has a casing member made of Teflon, inside which far infrared and magnetic members are installed in a closed compartment without any contact to the external environment. Depending on the application requirement, the dimension of the casing member could be adjusted accordingly and, in turn, the amounts of the far infrared and magnetic members are adjusted as well.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing the structure of a conventional fuel economizer.

FIG. 2 is a perspective view showing the fuel efficiency enhancing device according to an embodiment of the present invention.

FIG. 3 is a sectional view showing the inside of the fuel efficiency enhancing device of FIG. 2.

FIG. 4 is an application scenario of the fuel efficiency enhancing device of FIG. 2.

FIG. 5 is a sectional view showing the inside of a fuel efficiency enhancing device according to another embodiment of the present invention.

FIG. 6 is an application scenario of the fuel efficiency enhancing devices of FIGS. 2 and 5.

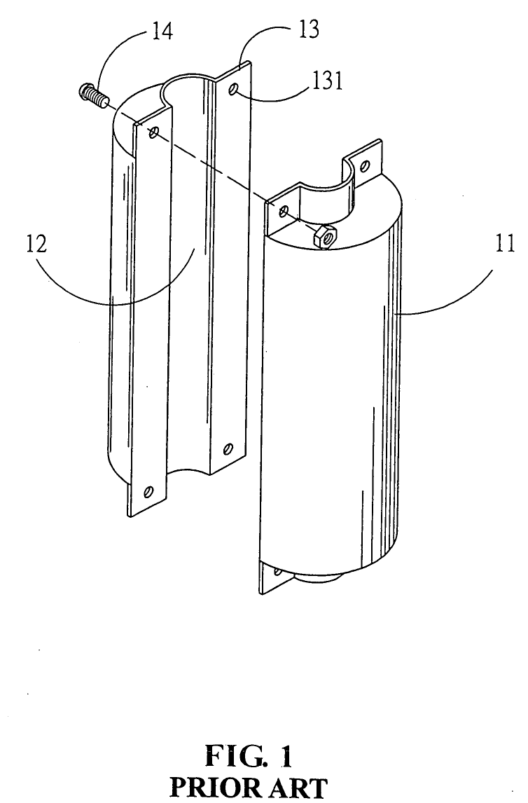

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

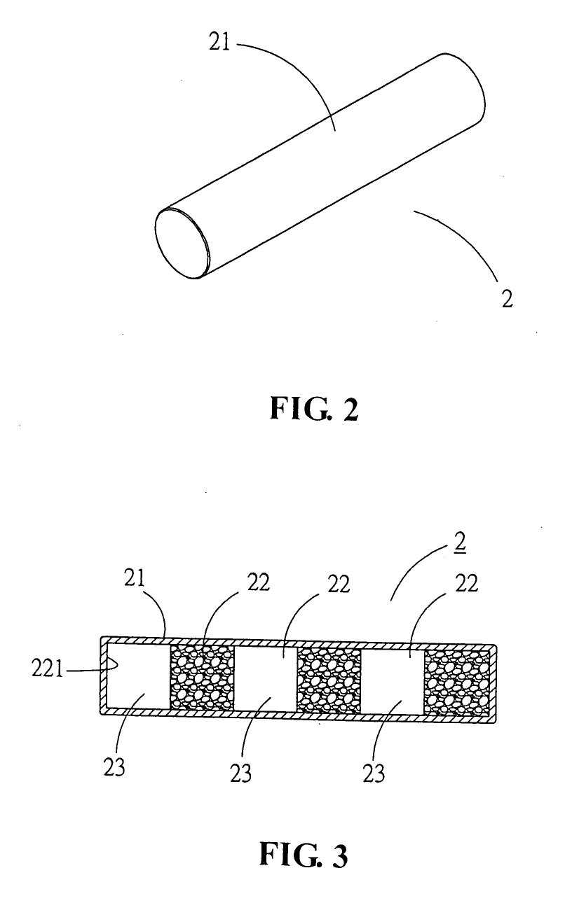

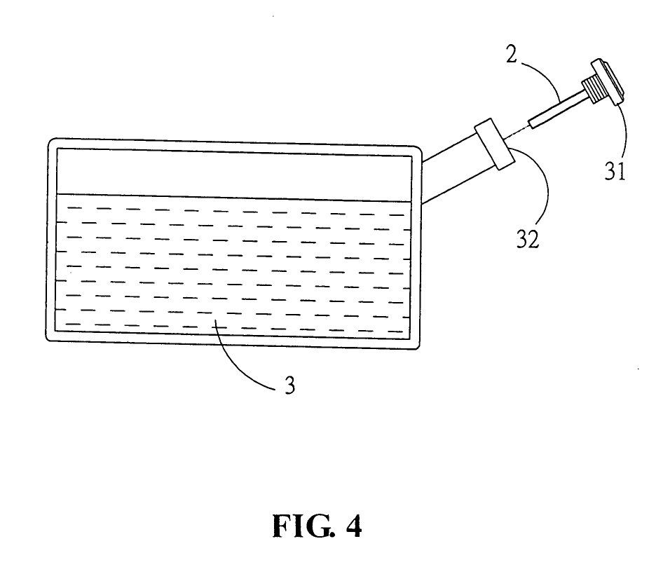

As shown in FIGS. 2 and 3, a fuel efficiency enhancing device 2 according to an embodiment of the present invention contains a cylindrical casing member 21, and, inside the casing member 21, three far infrared members 22 and three magnetic members 23,

The casing member 21 is made of Teflon (i.e., polytetrafluoroethylene or perfluoroalkoxy) with a closed compartment 211 inside, in which the far infrared members 22 and the magnetic members 23 are interleaved and closely attached with each other. The far infrared members 22 in the present embodiment are made of mineral particles that can radiate far infrared.

In application of the present embodiment, as shown in FIG. 4, the fuel efficiency enhancing device 2 is installed at the bottom of the cap 31 of the fuel tank 3. When the cap 31 is locked to the inlet 32 of the fuel tank 3, the fuel efficiency enhancing device 2 extends into the fuel tank 3. The far infrared radiated by the far infrared members 22 helps to break up the molecules of the fuel inside the fuel tank 3 while the magnetism of the magnetic members 23 help to activate the fuel molecules. As such, the fuel would be burned more completely to achieve better fuel economy and to produce fewer amounts of pollutants.

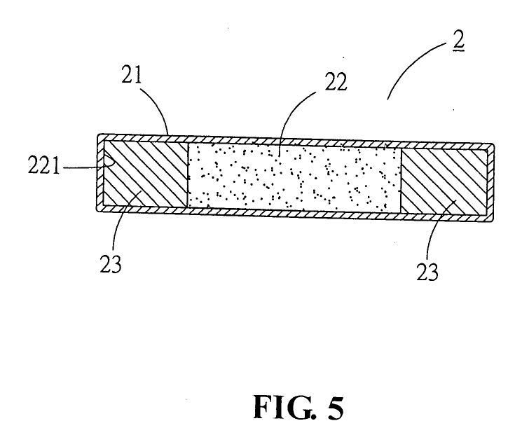

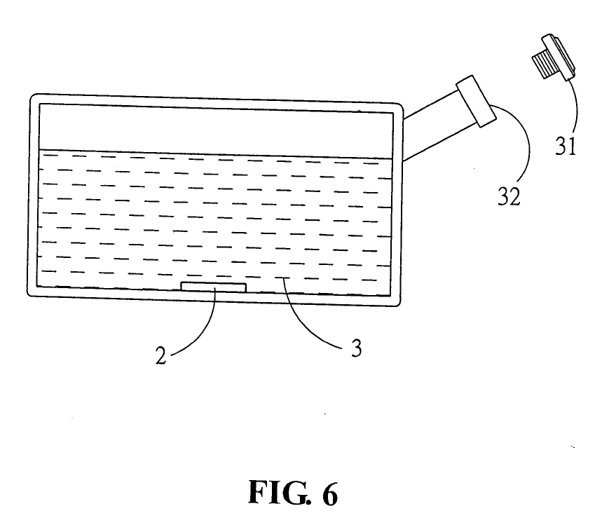

FIG. 5 shows a fuel efficiency enhancing device according to another embodiment of the present invention. As illustrated, there are two magnetic members 23 positioned at the two ends of the compartment 211 with a far infrared member 22 therebetween. In this embodiment, the far infrared member 22 contains powders of the minerals that can radiate far infrared. As shown in FIG. 6, the fuel efficiency enhancing device 2 could also be placed inside the fuel tank 3. Similarly, under the effect of the far infrared and the magnetism produced by the fuel efficiency enhancing device 2, the fuel inside the fuel tank 3 would be burned by the vehicle more completely as the far infrared radiated by the far infrared members 22 breaks up the fuel molecules while the magnetism of the magnetic members 23 activates the fuel molecules. Please note that, even though the fuel efficiency enhancing device 2 is used inside the fuel tank 3 in the foregoing embodiments, it should be quite obvious that the fuel efficiency enhancing device 2 could also be affixed to an appropriate location at the outside of the fuel tank 3. The far infrared and magnetism could still penetrate through the body of the fuel tank 3 and achieve the same activation effect to the fuel molecules.

The Teflon used for the casing member 21 has a number of advantages. Teflon is nonflammable and very stable under a wide range of temperatures (i.e., -180° C.˜260° C.); Teflon also is electrically insulating with a low thermal expansion coefficient and a low friction coefficient; and Teflon is able to withstand the erosion of various chemicals. As such, the fuel efficiency enhancing device 2 could be placed inside the fuel tank 3 as shown in FIG. 6 without being eroded by the fuel and thereby causing safety hazards to its usage.

The far infrared member 22 is made of minerals that can radiate far infrared. The minerals could be manufactured into particles or powders, or into a ceramic or a negative-ion form, or into an appropriate combination of the foregoing. Depending on the installation location, capacity, or other application requirements, the dimension of the Teflon casing member could be adjusted accordingly, which, in turn, determines the amounts of far infrared members and magnetic members.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fuel efficiency enhancing device for a motor vehicle, comprising:
at least a far infrared member made of at least a mineral that radiates far infrared;
at least a magnetic member that produces magnetism;
a casing member made of Teflon having a closed compartment inside that has no contact to the external environment;
wherein said far infrared and said magnetic members are positioned and interleaved inside said closed compartment; and far infrared and magnetism produced by said fuel efficiency enhancing device breaks up and activates the molecules of the fuel of said motor vehicle.

2. The fuel efficiency enhancing device according to claim 1, wherein said far infrared member is in the form of mineral powders.

3. The fuel efficiency enhancing device according to claim 1, wherein said closed compartment has an elongated shape and two said far infrared members are installed at the two ends of said closed compartment.

4. The fuel efficiency enhancing device according to claim 1, wherein said fuel efficiency enhancing device is installed at the bottom of the cap of the inlet of said motor vehicle's fuel tank.

5. The fuel efficiency enhancing device according to claim 1, wherein said fuel efficiency enhancing device is installed inside the fuel tank of said motor vehicle.

6. The fuel efficiency enhancing device according to claim 1, wherein said fuel efficiency enhancing device is installed at an appropriate location on the outside of the fuel tank of said motor vehicle.
